(19) United States
(12) Patent Application Publication
(10) Pub. No.: US 2026/0120619 A1
(43) Pub. Date: Apr. 30, 2026

(54) DISPLAY CONTROL METHOD AND APPARATUS FOR LOW-POWER DRIVING

(71) Applicant: SAPIEN SEMICONDUCTORS INC., Gyeonggi-do (KR)

(72) Inventors: Dae Young Jung, Gyeonggi-do (KR); Eun Byeol Kim, Gyeonggi-do (KR)

(21) Appl. No.: 19/374,170

(22) Filed: Oct. 30, 2025

(30) Foreign Application Priority Data
Oct. 30, 2024 (KR) 10-2024-0150948
Nov. 12, 2024 (KR) 10-2024-0159795
Jul. 23, 2025 (KR) 10-2025-0099940

(51) Int. Cl. G09G 3/20

(52) U.S. Cl. CPC G09G 3/2096; G09G 2310/0286; G09G 2310/04; G09G 2310/08; G09G 2330/023

(57) ABSTRACT

A partial display control method and an apparatus for low-power operation are disclosed. The display control apparatus may include a pixel array in which pixels each having an in-pixel memory are arranged, a processor configured to output sequential line activation signals for respective lines of the pixel array, and to logically generate a flag bit indicating whether to update pixel data of each pixel included in a line activated by the line activation signal.

### CROSS-REFERENCE TO RELATED APPLICATION

This application claims priority from and the benefit of Korean Patent Application No. 10-2024-0150948 filed on October 30, 2024, 10-2024-0159795 filed on November 12, 2024, 10-2025-0099940 filed on July 23, 2025 in the Korean Intellectual Property Office, the disclosures of which are incorporated herein by reference.

### TECHNICAL FIELD

Example embodiments relate to a digital display system, and more particularly, to a method and apparatus for controlling to update only a portion of a display screen in a display apparatus requiring low-power operation, such as an augmented reality (AR) display apparatus.

### BACKGROUND

Display apparatus can be applied to a wide range of fields, from small mobile devices to large outdoor display apparatuses. In particular, displays are increasingly utilized in various applications such as in-vehicle devices, augmented reality (AR) devices, mixed reality (MR) devices, and extended reality (XR) devices.

Accordingly, improvements are still required in various characteristics including area, form factor, resolution, processing time, manufacturing cost, reliability, and response speed.

In display driving, when an image change occurs only in a partial area of the screen, controlling the display by rewriting, storing, and scanning the entire image frame may increase power consumption.

In the case of portable devices, it may be necessary to control a driving circuit in consideration of the power consumption of the display apparatus, and a method for selectively controlling display pixels may be required depending on the application being executed.

For example, in the case of an AR device, since applications that mainly display simple information such as text or indicators may be used, low-power operation through partial display control may be required.

### BRIEF SUMMARY

An object of the present disclosure is to provide a method and apparatus for improving power consumption of a display apparatus through embodiments and for partially controlling the display according to an application.

Another object of the present disclosure is to provide a method and apparatus for controlling to update only a portion of image frame data by providing an in-pixel memory in individual pixels of the display and utilizing the in-pixel memory.

The present disclosure also provides a method and apparatus for controlling to update only a portion of image frame data without increasing the capacity of the in-pixel memory provided in individual pixel regions.

According to one embodiment of the present disclosure, a display control apparatus for low-power operation comprises: a pixel array including pixels, each pixel having an in-pixel memory for storing pixel data, a scan controller configured to output sequential line activation signals for respective lines of the pixel array, and a shift register controller configured to logically generate a flag bit indicating whether to update pixel data of each pixel included in a line activated by the line activation signal, wherein each pixel included in the activated line selectively updates pixel data stored in the in-pixel memory based on the line activation signal and a logic value of the flag bit.

Each of the pixels further comprises pixel update control logic circuit configured to output a pixel update control signal by performing a logical AND operation of the line activation signal and the flag bit, and the in-pixel memory included in each pixel is configured to maintain or update the pixel data based on the pixel update control signal.

The shift register controller may receive a timing signal reflecting information of display pixels to be updated, and may logically generate the flag bit based on the timing signal.

The display pixel information to be updated may include any one of: information for a preset zone of a display panel; information set for each line of the display panel; and information set for an individual pixel of the display panel.

The shift register controller may transmit the pixel data and the flag bit for each column of the pixel array.

The in-pixel memory may store only display pixel data for display purposes and may not include a separate storage area for the flag bit.

When the flag bit has a first logic value, the in-pixel memory of a corresponding pixel may be updated with new pixel data, and when the flag bit has a second logic value, the in-pixel memory of the corresponding pixel may maintain previously stored pixel data.

According to another embodiment of the present disclosure, a method of driving a display according to an embodiment of the present disclosure comprises: outputting, by a scan controller, sequential line activation signals for respective lines of the pixel array, logically generating, by a shift register controller, a flag bit indicating whether to update pixel data of each pixel included in a line activated by the line activation signal, and selectively updating, by each pixel included in the activated line, the pixel data stored in the in-pixel memory based on the line activation signal and a logic value of the flag bit.

The selectively updating the pixel data may comprise: generating, by each pixel, a pixel update control signal by performing a logical AND operation of the line activation signal and the flag bit; and maintaining or updating, based on the pixel update control signal, the pixel data in the in-pixel memory.

The logically generating of the flag bit may comprise: receiving, by the shift register controller, a timing signal reflecting display pixel information to be updated; and logically generating the flag bit based on the timing signal.

The selectively updating the pixel data may comprise: updating, when the flag bit has a first logic value, the in-pixel memory of a corresponding pixel with new pixel data, and maintaining, when the flag bit has a second logic value, previously stored pixel data in the in-pixel memory of the corresponding pixel.

According to another embodiment of the present disclosure, a display control apparatus for low-power operation, comprising: a receiving interface configured to receive a timing signal from a host device, the timing signal reflecting display position information requiring updates in entire frame data; a logic controller configured to check a preset porch section and an enable section of the timing signal, and to determine a display position corresponding to the enable section of the timing signal; and a panel interface configured to transmit video data input in the enable section of the timing signal to a display panel so as to write the video data to pixels provided at the display position.

The logic controller may be configured to: determine row information of the display position based on a horizontal synchronization signal included in the timing signal, and determine column information based on a time counted from an end of the porch section to the enable section of the timing signal.

The logic controller may be configured to: generate update bits indicating whether to update display pixels corresponding to the row information and the column information.

Pixels of the display panel may receive the update bits and determine whether to reset or maintain an in-pixel memory of the pixels based on the update bits.

According to embodiments of the present disclosure, a partial data write mode may be provided, and power consumption of a display apparatus may be improved through the partial data write mode.

In addition, in applications such as augmented reality (AR) devices in which only a portion of a display area requires data changes across the entire display area, power consumption can be significantly improved through embodiments of the present disclosure.

Furthermore, a method may be provided for controlling partial data updates through control of a display backplane rather than entire apparatus-level control.

In another embodiment, a display control apparatus for low-power operation comprises a receiving interface configured to receive a timing signal reflecting display position information requiring updates, a logic controller configured to determine display positions and generate update bits based on the timing signal, and a panel interface configured to transmit the video data and update bits to the display panel.

The logic controller may determine row information based on a horizontal synchronization signal and column information based on timing from a porch section, and may generate update bits indicating whether to update corresponding display pixels. The display panel pixels may receive the update bits and determine whether to reset or maintain their in-pixel memories accordingly.

### BRIEF DESCRIPTION OF THE DRAWINGS

Embodiments will be described in more detail with regard to the figures, wherein like reference numerals refer to like parts throughout the various figures unless otherwise specified, and wherein:

FIG. 1 is an exemplary diagram of a display control apparatus according to an embodiment of the present disclosure.

FIG. 2 is an exemplary diagram of the display apparatus according to an embodiment of the present disclosure.

FIGS. 3A and 3B and FIG. 4 are exemplary diagrams for explaining examples in which the present disclosure is applied to various applications.

FIG. 5 illustrates exemplary timing signals of a comparative embodiment , and FIG. 6 illustrates exemplary timing signals according to an embodiment of the present disclosure.

FIGS. 7 and 8 are another exemplary timing signals according to an embodiment of the present disclosure and display control based thereon.

FIG. 9 is an exemplary diagram of a pixel operation of a display panel according to an embodiment of the present disclosure.

FIG. 10 is an exemplary flowchart for illustrating a display control method for low-power operation according to an embodiment of the present disclosure.

FIG. 11 is an exemplary diagram for another display control apparatus according to an embodiment of the present disclosure.

FIG. 12 is an exemplary diagram of an internal configuration and operation of an individual pixel in FIG. 11.

FIGS. 13 to 15 are exemplary diagrams for explaining examples of pixel-level partial updates in FIG. 11.

FIG. 16 is an exemplary diagram for a line update control operation, pixel update control operation, and memory update control operation according to an embodiment of the present disclosure.

FIG. 17 is an exemplary diagram of operation of an in-pixel memory and a shift register controller according to an embodiment of the present disclosure.

FIG. 18 is an exemplary diagram illustrating an example of a pixel driving circuit provided for each pixel according to an embodiment of the present disclosure.

### DETAILED DESCRIPTION OF THE DISCLOSURE

Structural or functional descriptions are merely illustrated for the purpose of describing embodiments according to the concept of the present disclosure, and embodiments according to the concept of the present disclosure may be implemented in various forms and are not limited to the embodiments described herein. The embodiments according to the concept of the present disclosure may be subject to various modifications and may take various forms, and thus the embodiments are illustrated in the drawings and described in detail in the present specification. However, this is not intended to limit the embodiments according to the concept of the present disclosure to specific disclosed forms, and includes modifications, equivalents, or alternatives that fall within the spirit and scope of the present disclosure.

Terms such as "first" and "second" may be used to describe various elements, but such elements should not be limited by these terms. The terms are used only for the purpose of distinguishing one element from another; for example, a first element may be referred to as a second element, and similarly, a second element may be referred to as a first element, without departing from the scope of the concept of the present disclosure.

When an element is referred to as being "connected" or "coupled" to another element, it may be directly connected or coupled to the other element or intervening elements may be present therebetween. In contrast, when an element is referred to as being "directly connected" or "directly coupled" to another element, it should be understood that there are no intervening elements therebetween. Expressions describing relationships between elements, such as "between" and "directly between" or "adjacent to," should be interpreted in the same manner.

The terminology used herein is intended only to describe particular embodiments and is not intended to be limiting of the present disclosure. Singular expressions are intended to include the plural form unless the context clearly indicates otherwise. In the present specification, terms such as "comprise" or "have" are intended to specify the presence of stated features, integers, steps, operations, elements, components, or combinations thereof, but do not preclude the possibility of the presence or addition of one or more other features, integers, steps, operations, elements, components, or combinations thereof.

Unless otherwise defined, all terms used herein, including technical and scientific terms, have the same meaning as commonly understood by one of ordinary skill in the art to which the present disclosure pertains. Terms that are defined in generally used dictionaries should be interpreted as having meanings consistent with the contextual meaning in the relevant art and are not to be interpreted in an idealized or overly formal sense unless expressly defined herein.

Hereinafter, embodiments will be described in detail with reference to the accompanying drawings. However, the scope of the patent application is not limited or restricted by these embodiments. The same reference numerals provided in the respective drawings denote the same elements.

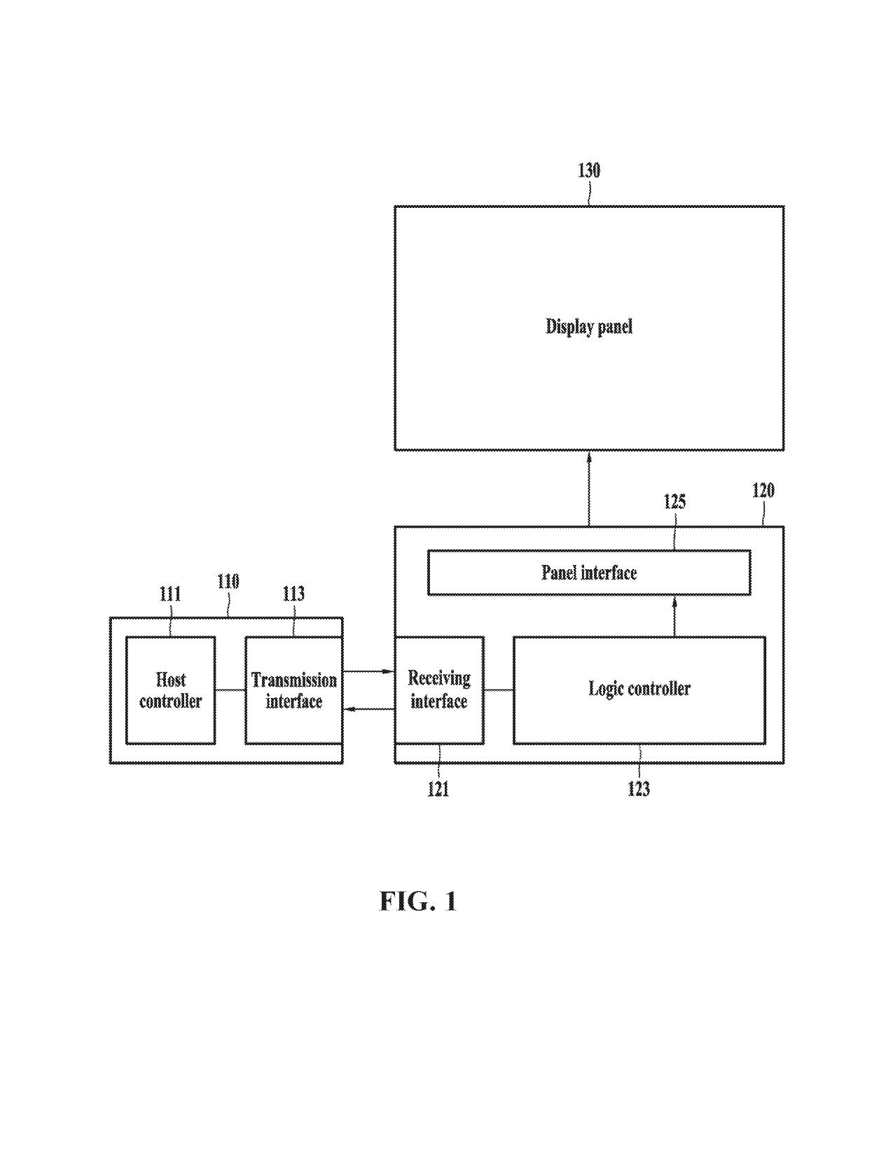

FIG. 1 is a diagram for explaining a configuration of a display apparatus according to an embodiment of the present disclosure.

Referring to FIG. 1, the display apparatus includes a host 110, backplane hardware logic 120, and a display panel 130. The backplane hardware logic 120 may be referred to as a display driver IC or a display control apparatus.

In the present specification, the backplane hardware logic 120 or some components within the backplane hardware logic 120 may be referred to as a "display control apparatus." In addition, the backplane hardware logic 120 and the display panel 130 together may be referred to as the display control apparatus. Furthermore, some components of the backplane hardware logic 120 and the display panel 130 may also be referred to as the display control apparatus.

The host 110 may control the backplane hardware logic 120. The host 110 may support a video stream interface.

The host 110 may be implemented as a system on chip (SoC), an application processor (AP), or a mobile AP.

The host 110 may include a host controller 111 and a transmission interface 113.

The host controller 111 may include a CPU and may execute firmware or software to support the video stream interface.

The transmission interface 113 may perform an interface function capable of supporting the video stream interface. The transmission interface 113 may support MIPI, eDP, or a high-speed serial interface.

The transmission interface 113 may transmit image data, video data, and timing signals to the backplane hardware logic 120. In this case, the timing signals may include at least one of a vertical synchronization signal (Vsync), a horizontal synchronization signal (Hsync), a clock signal, and a data enable signal.

The host 110 and the backplane hardware logic 120 may be connected to each other via a line for transmitting a video stream and a line for transmitting timing signals.

The backplane hardware logic 120 includes a receiving interface 121, a logic controller 123, and a panel interface 125.

The receiving interface 121 may receive a video stream and timing signals transmitted from the host 110.

The receiving interface 121 receives a timing signal from the host 110 in which display position information requiring updates in the entire frame data is reflected. In addition, the receiving interface 121 may also receive frame data corresponding to the timing signal.

The logic controller 123 may check a preset porch section and an enable section of the timing signal, and may determine a display position corresponding to the enable section of the timing signal.

The logic controller 123 may determine update bits for each pixel of the display panel at separate time intervals based on a logic low section or a logic high section of the timing signal.

Specific examples of the display position determination and the update bit determination by the logic controller 123 will be described with reference to FIGS. 6 to 8.

The panel interface 125 may transmit video data input in the enable section of the timing signal to the display panel 130 so as to write the video data to pixels provided at the display position. In addition, the panel interface 125 may transmit the determined update bits to the display panel 130.

The panel interface 125 may include a line buffer or a shift register.

The panel interface 125 may write analog signals corresponding to display data, and scan the written signals to transmit them to data lines provided in the display panel 130.

The display panel 130 may be a panel in which a plurality of light-emitting elements and pixel circuits for driving the light-emitting elements form individual pixels, and a plurality of pixels are arranged. The pixels included in the display panel 130 may each include an in-pixel memory capable of storing digital data therein. The in-pixel memory may store image data and may be implemented as SRAM, a flip-flop, a latch, or a shift register.

The display panel 130 may perform maintenance or update of data stored in the in-pixel memory of each line or each pixel based on update bits. The display panel 130 may reset the data stored in the in-pixel memory before performing a data update.

The display panel 130 may display an image using an n-bit digital video signal capable of representing 1 to 2ⁿ gray scales.

The display panel 130 may include a plurality of pixels arranged in a predetermined pattern, for example, a matrix pattern, a zigzag pattern, or other various patterns. Each pixel emits a single color, for example, one of red, blue, green, or white. A pixel may also emit a color other than red, blue, green, or white.

Each pixel may operate on a frame basis. One frame may be composed of a plurality of subframes. Each subframe may include a data writing period and a light-emission period. In the data writing period, digital data of a predetermined number of bits may be stored in the memory included in the pixel. In the light-emission period, the stored digital data of the predetermined number of bits is read in synchronization with a clock signal, the digital data is converted into a PWM signal, and the pixel may represent gradations. The light-emission period of the subframe may be the sum of times allocated to each bit of the digital data.

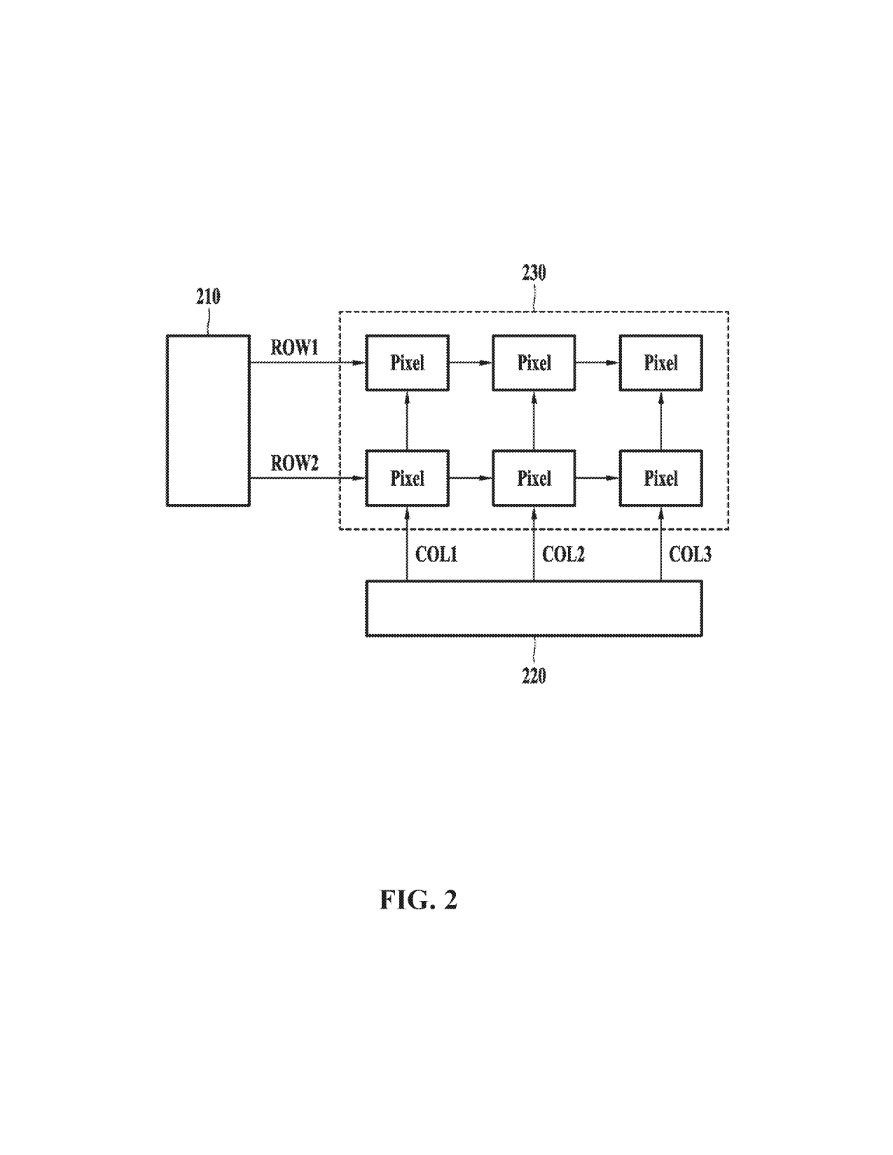

FIG. 2 is a diagram for explaining another example of a display control apparatus according to an embodiment of the present disclosure.

Referring to FIG. 2, the display control apparatus may include a scan controller 210, a data controller 220, and a display panel 230.

The scan controller 210 and the data controller 220 may be components included in the panel interface 125 of FIG. 1.

The display panel 230 may have the same configuration as the display panel 130 of FIG. 1.

The scan controller 210 may control updates of in-pixel memories on a line basis.

For example, when ROW1 and ROW2 are enabled, video data of column lines COL1, COL2, and COL3 may be written to each pixel. That is, pixels included in lines that are not enabled may not perform an update of the in-pixel memory. In this case, the data stored in the in-pixel memory is maintained, and light emission may be performed during a light-emission period according to the maintained data.

In addition, regardless of control by the scan controller 210, whether to update data may be determined on a pixel basis.

For pixel-by-pixel data updates, the data controller 220 may input update bits to each pixel, and each pixel requires an additional configuration for determining whether to update data.

Additional description regarding pixel-by-pixel data updates will be provided with reference to FIGS. 6 to 8 and FIG. 9.

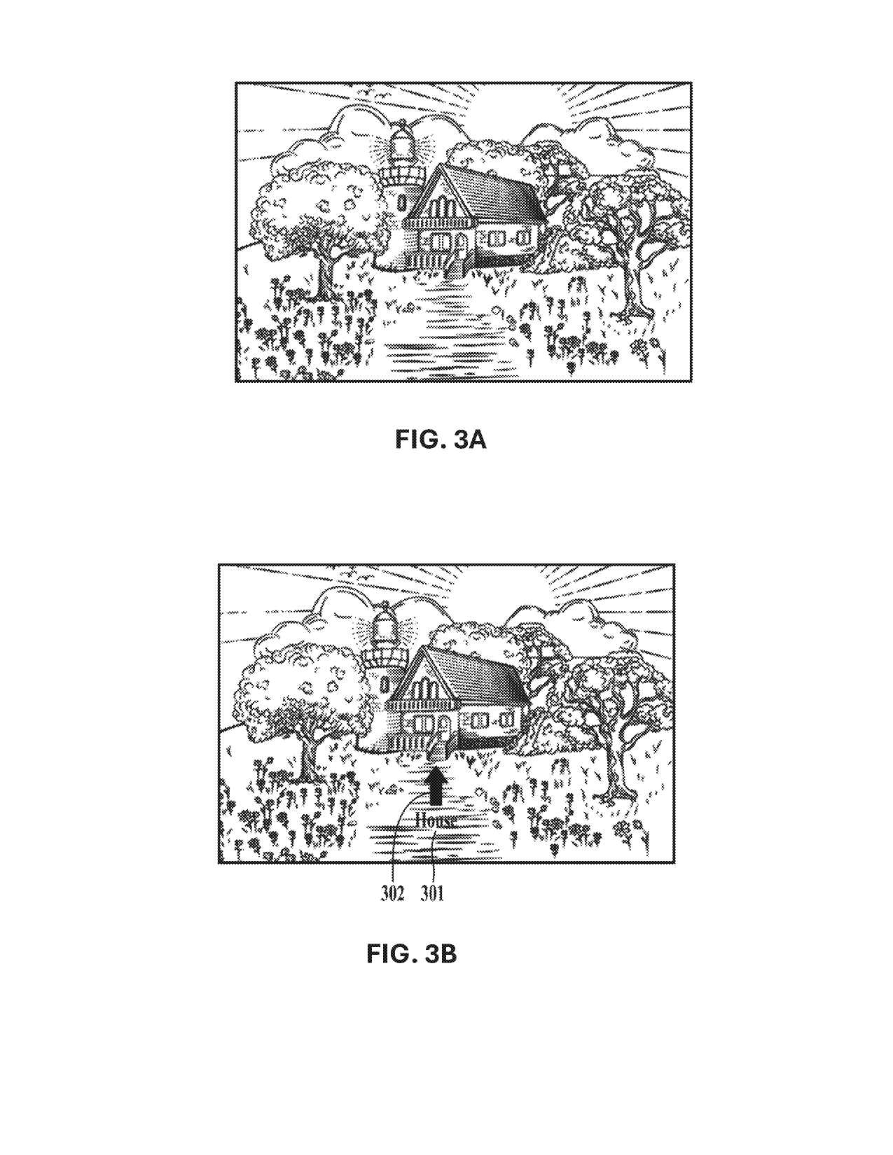

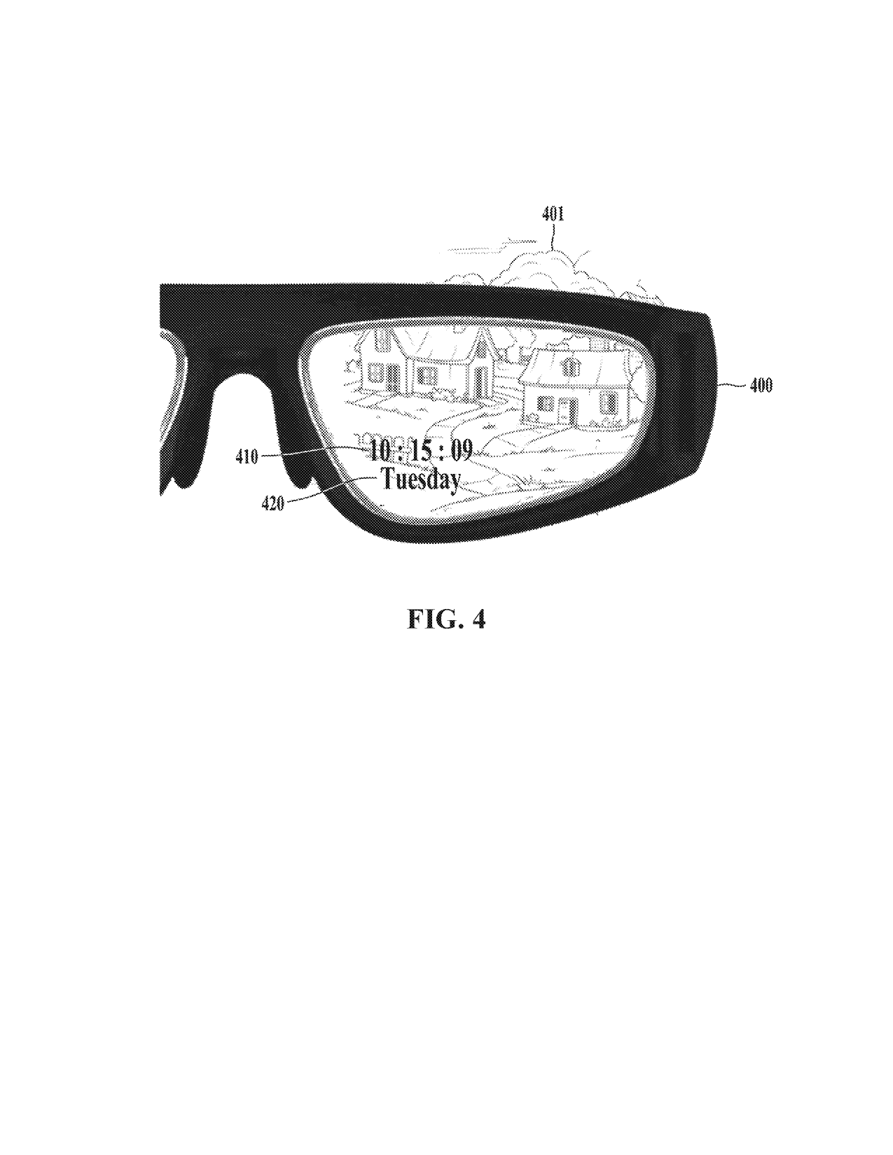

FIGS. 3A and 3B and FIG. 4 are diagrams for explaining examples in which the present disclosure is applied to various applications.

Referring to FIG. 3A illustrates an image displayed by previous frame data, and (B) illustrates an image displayed by current frame data.

Comparing FIG. 3A and FIG. 3B from the perspective of video data or image data, FIG. 3B may be viewed as having performed a 'partial update' or 'partial change' only for the area or pixel values in which the text information "House" 301 and the arrow image 302 are displayed in FIG. 3A.

In this case, updating the entire frame data may be considered inefficient in terms of power consumption. In particular, in small devices such as AR devices, a display driver IC (DDIC) or a backplane may not be provided with a frame buffer. Accordingly, a partial update utilizing in-pixel memory is required.

FIG. 4 illustrates a user's screen perception when viewing a real-world scene 401 through smart glasses 400. In this case, to provide augmented reality information, text information 410 and 420 may be provided in a portion of the entire display area of the smart glasses 400.

Accordingly, a partial update may be applied to the areas where the text information 410 and 420 is provided. The first text information 410 may be, for example, time information including a second hand. The area where the second hand is displayed may require more frequent data updates compared to other areas, and data updates may be controlled on a pixel-by-pixel basis.

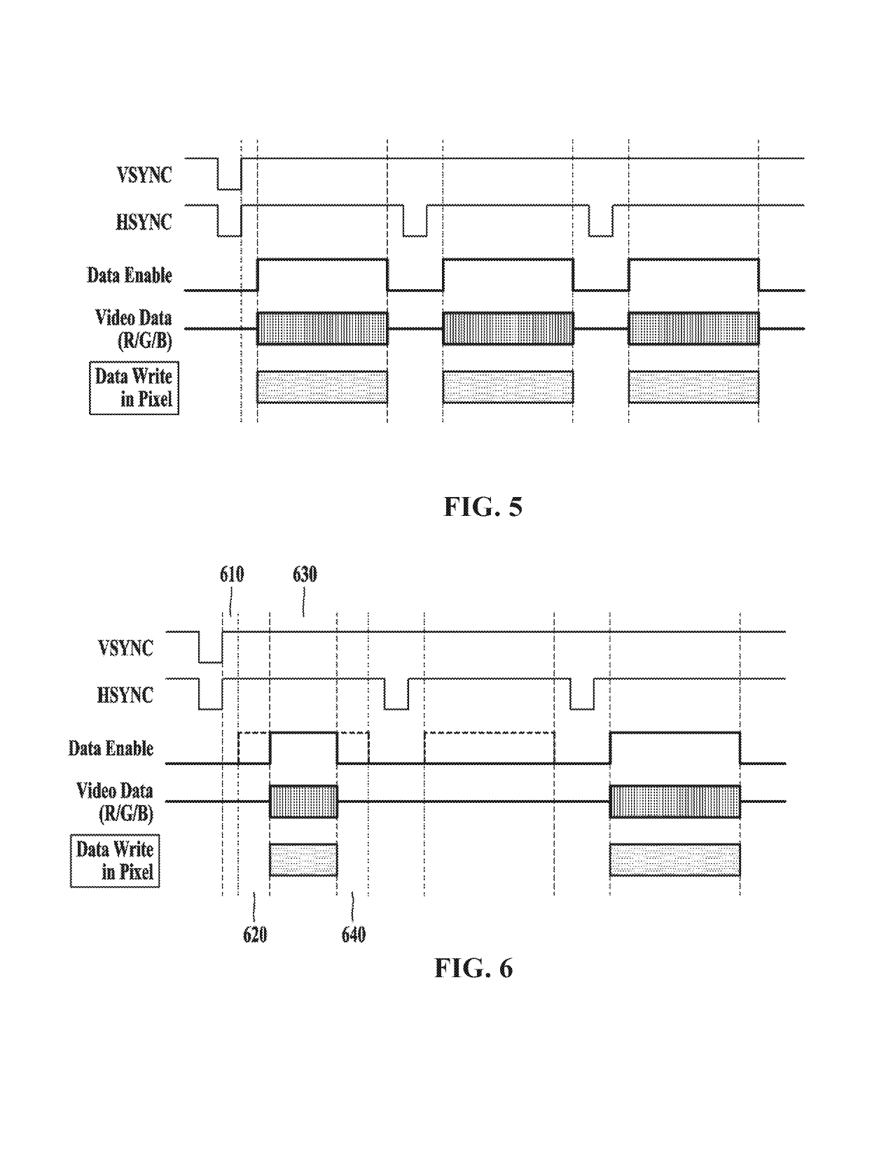

FIG. 5 illustrates a timing signal according to related art, and FIG. 6 illustrates a timing signal according to an embodiment of the present disclosure.

Referring to FIG. 5, VSYNC represents a vertical synchronization signal. The vertical synchronization signal is a timing signal for distinguishing display time on a frame basis.

HSYNC represents a horizontal synchronization signal. The horizontal synchronization signal is a signal for distinguishing display time on a line basis of the display panel.

Data Enable represents a section in which valid data is input. When the data enable signal is on or activated, the data is valid, and when the data enable signal is off or deactivated, the data is invalid.

Video data input during a valid section of the Data Enable may be written to pixels of the display panel.

Referring to FIG. 6, the Data Enable is on or activated only in a section where there is data to be updated in the in-pixel memory.

In FIG. 6, assuming that the Data Enable is a timing signal in which display position information requiring updates in the entire frame data is reflected,

the Data Enable signal may be a signal input to the apparatus or a signal generated based on a setting value input to the apparatus.

In this case, the display control apparatus may determine whether to update data on a line basis or pixel basis starting from a point when a porch section 610 ends after an HSYNC signal is input.

Pixels corresponding to a section 620 without Data Enable after the porch section 610 ends do not perform updates of video data, and pixels corresponding to a section 630 with Data Enable activated may perform updates of video data.

Further, pixels corresponding to a section 640 where Data Enable is deactivated maintain data of a previous frame stored in the in-pixel memory without updating video data.

That is, the display control apparatus determines a display position corresponding to the enable section of the timing signal, and the display position may be determined on a pixel basis or a line basis.

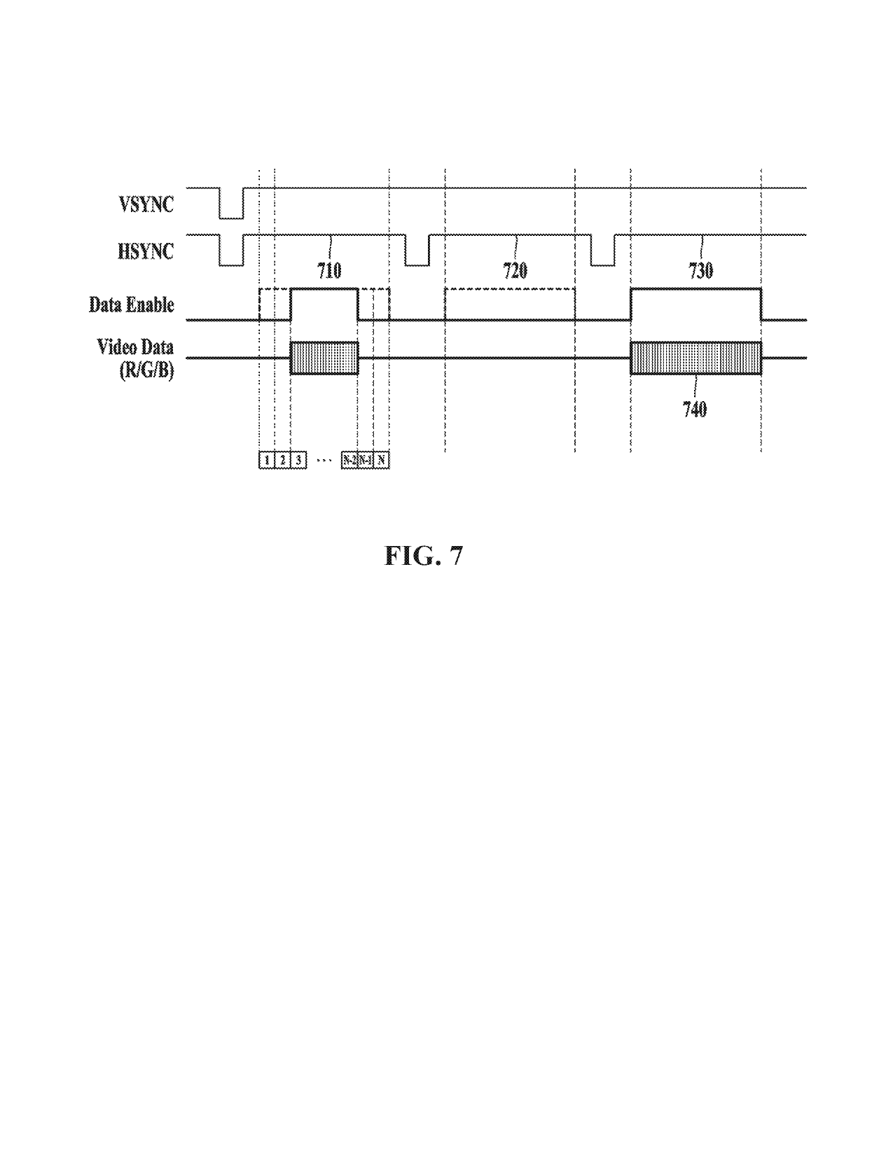

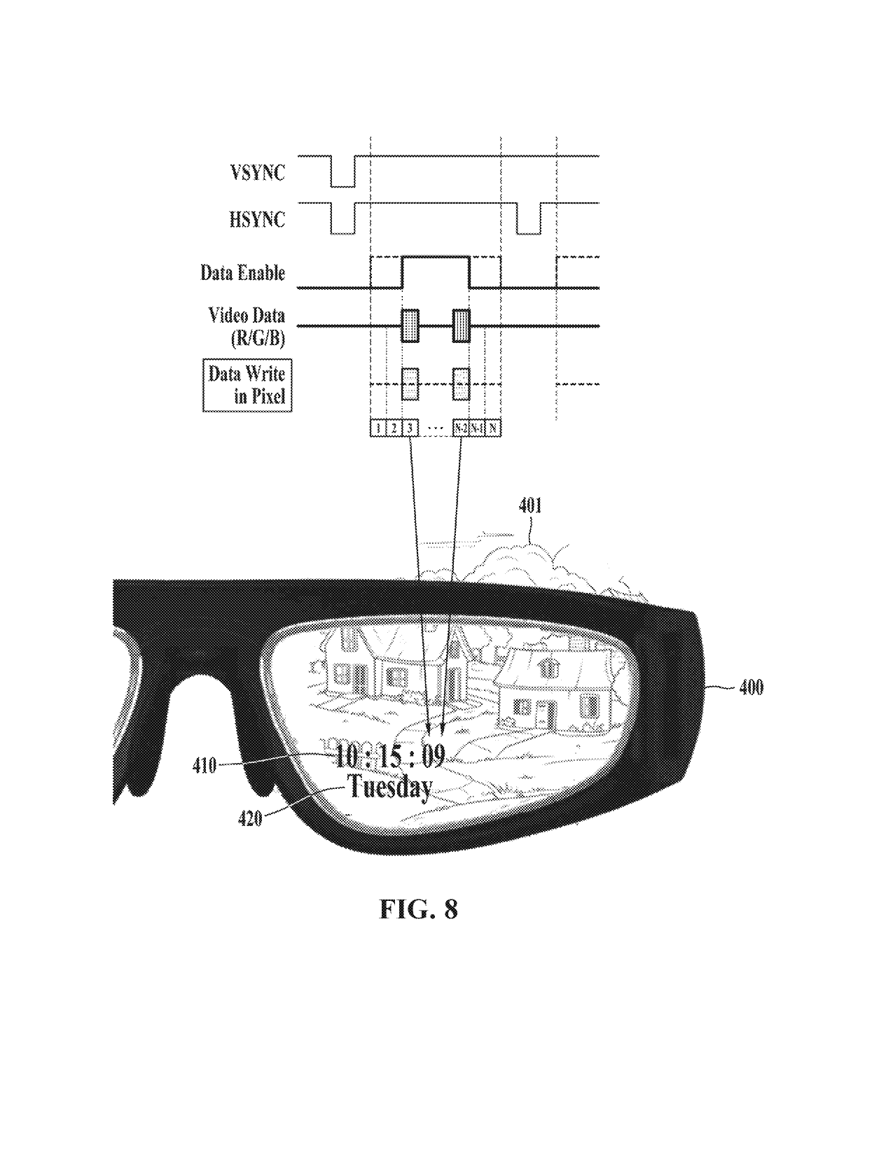

FIGS. 7 and 8 are diagrams for explaining a timing signal according to an embodiment of the present disclosure and display control based thereon.

Referring to FIG. 7, HSYNC and Data Enable may be referred to as timing signals in which display position information requiring updates in the entire frame data is reflected.

In this case, the display panel may include a first line 710, a second line 720, and a third line 730. Each line may include pixels 1, 2, 3 … N-2, N-1, and N.

A logic controller of the display control apparatus may determine row information of a display position based on a horizontal synchronization signal included in the timing signal.

From the perspective of the display panel, the display positions requiring updates are the first line 710 and the third line 730.

The logic controller of the display control apparatus may determine column information based on a time counted from the end of a porch section to an enable section of the timing signal.

For example, the logic controller may determine pixels 1 and 2 of the first line 710 as "no update" based on a time counted from the end of the porch section to a section where the Data Enable is activated.

For example, the logic controller may determine pixels 3 to N-2 of the first line 710 to be updated based on a time counted from a section where the Data Enable is activated.

The logic controller may generate update bits indicating whether to update display pixels corresponding to the row information and column information based on the Data Enable.

For convenience of explanation, the phrase "determine column information based on a time counted to the enable section of the timing signal" is used; however, the logic controller may determine whether to update on a pixel-by-pixel basis.

For example, the logic controller may generate an update bit "0" for pixel 1 and transmit the update bit to the display panel; generate an update bit "0" for pixel 2 and transmit the update bit to the display panel; generate an update bit "1" for pixel 3 and transmit the update bit to the display panel; generate an update bit "1" for pixel N-2 and transmit the update bit to the display panel; generate an update bit "0" for pixel N-1 and transmit the update bit to the display panel; and generate an update bit "0" for pixel N and transmit the update bit to the display panel.

Referring to FIG. 7, the Data Enable corresponding to the third line 730 indicates that it is enabled for all pixels. Accordingly, the update bit for each pixel of the third line 730 may be set to "1," and the video data 740 to be input to the third line 730 may be input to each pixel of the third line 730.

Meanwhile, the on-section of the Data Enable and the input section of the video data may not coincide. Referring to FIG. 8, it can be seen that an embodiment is possible in which video data is input to only some pixels in a section where the Data Enable is enabled.

Accordingly, the logic controller may determine whether to update for each pixel by checking the input of video data together with the timing signal. The logic controller may determine pixel positions requiring updates based on at least one of the on-section of the Data Enable or the input section of the video data according to a protocol agreed upon with the host.

The example illustrated in FIG. 8 corresponds to a case in which only some pixels of the first text information 410 of FIG. 4 are updated. For example, among pixels 1 to N, only pixels 3 and N-2 may be updated. The logic controller may generate an update bit "1" for pixel 3 corresponding to a section in which video data is input within a section where the Data Enable is enabled, and may transmit the update bit "1" to pixel 3. In addition, the logic controller may generate an update bit "1" for pixel N-2 corresponding to a section in which video data is input within a section where the Data Enable is enabled, and may transmit the update bit "1" to pixel N-2.

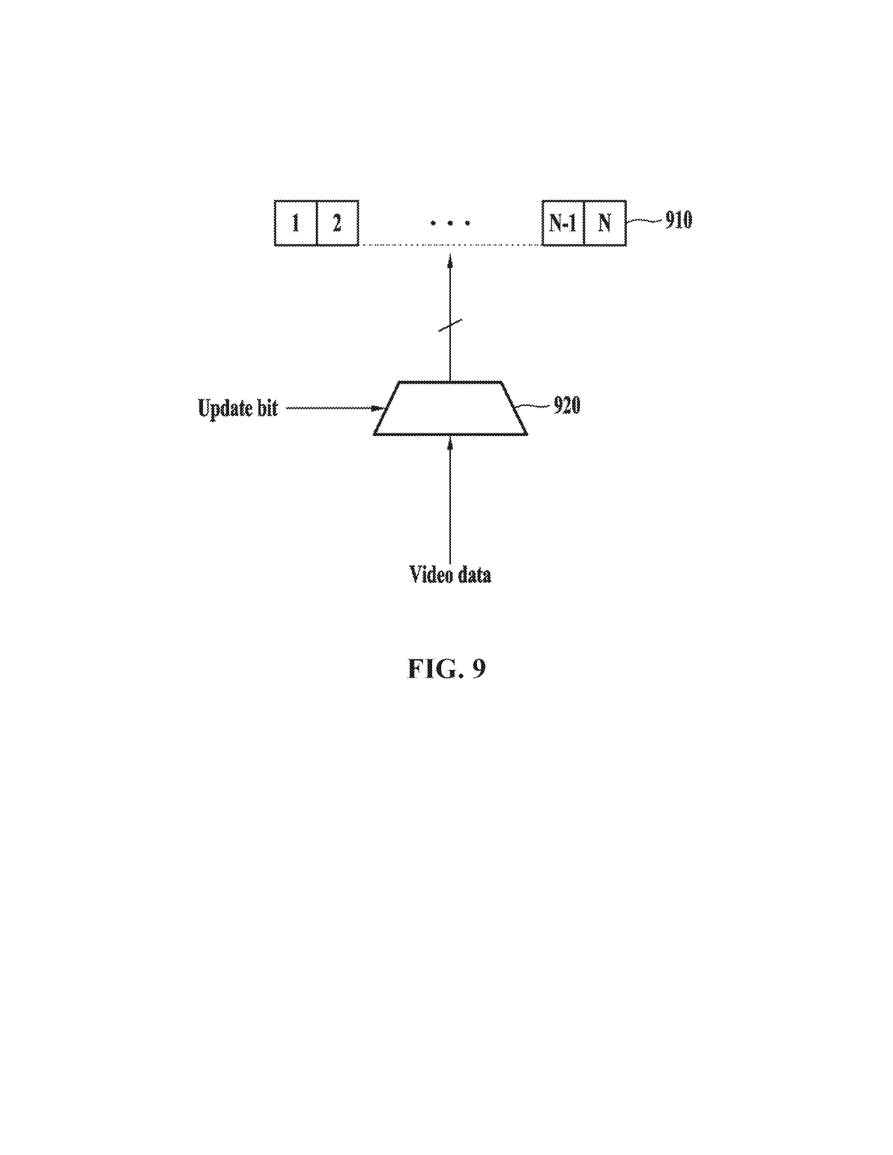

FIG. 9 is a diagram for explaining pixel operation of a display panel according to an embodiment of the present disclosure.

Referring to FIG. 9, each pixel may include an in-pixel memory 910 and a path controller 920.

The in-pixel memory 910 may store m-bit video data applied through a column line or a panel interface during a data write period. The in-pixel memory 910 may store at least 1-bit of data. The in-pixel memory 910 may be implemented with a memory of less than m bits depending on a driving frequency. The in-pixel memory 910 may include a shift register. The in-pixel memory 910 may be implemented with one or more transistors. The in-pixel memory 910 may be implemented as random access memory (RAM), for example, SRAM or DRAM.

The in-pixel memory 910 may reset the memory and update the video data when video data is applied through the path controller 920.

The path controller 920 may perform the function of a comparator, a switch, or a multiplexer.

The path controller 920 may receive an update bit, and when the update bit is "0," may not transfer the video data to the in-pixel memory 910.

Here, when the update bit is "0," there may be no video data input from the host. Accordingly, when the update bit is "0," the path controller 920 may not perform a path control operation, and may simply perform a function of transferring a signal to the in-pixel memory 910 to indicate whether to maintain the data.

The path controller 920 may receive an update bit, and when the update bit is "1," may transfer the video data to the in-pixel memory 910.

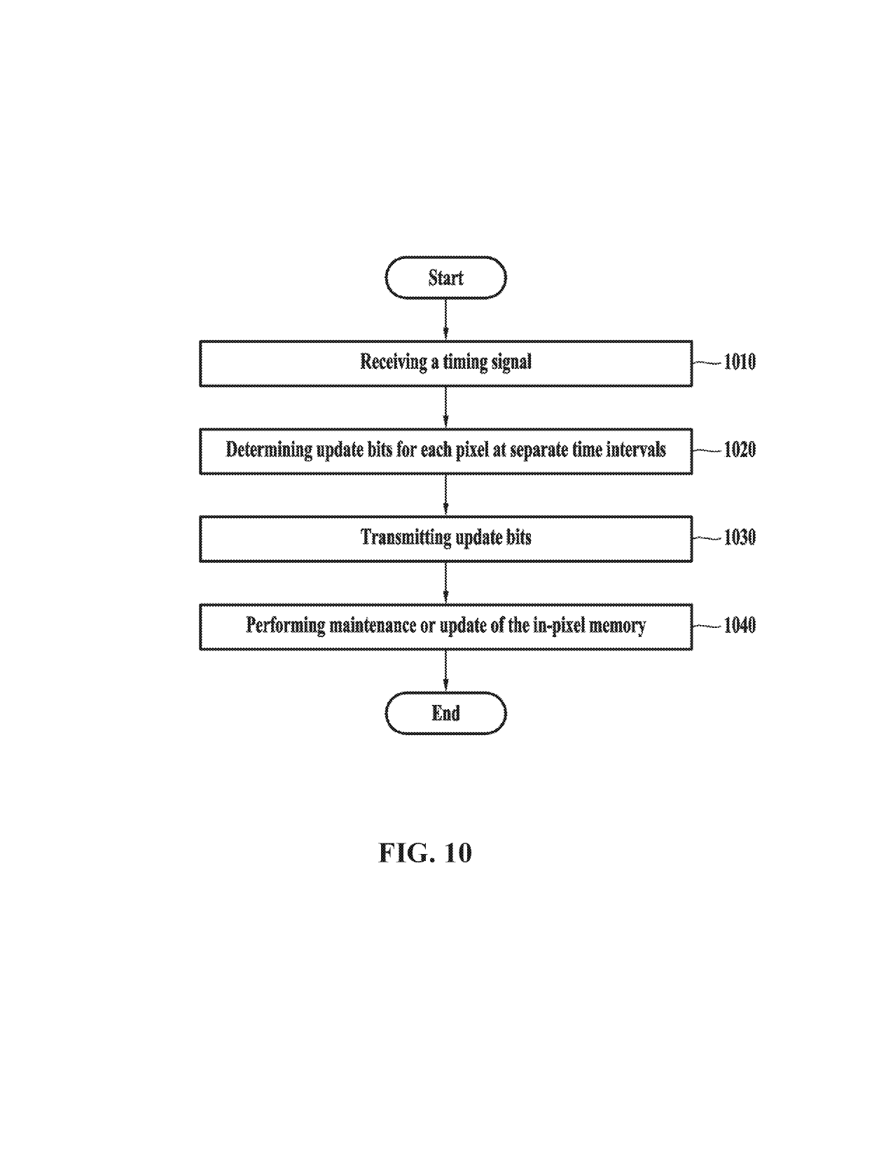

FIG. 10 is a flowchart for explaining a display control method for low-power operation according to an embodiment of the present disclosure.

The method illustrated in FIG. 10 may be performed by the apparatus shown in FIG. 1 or FIG. 2.

Referring to FIG. 10, in step 1010, the display control apparatus receives a timing signal from the host in which display position information requiring updates in the entire frame data is reflected.

In step 1020, the display control apparatus checks a preset porch section and an enable section of the timing signal, and may determine a display position corresponding to the enable section of the timing signal.

Determining the display position may include determining row information of the display position based on a horizontal synchronization signal included in the timing signal, and determining column information based on a time counted from the end of the porch section to the enable section of the timing signal.

The display position information requiring updates may include any one of: information for a preset zone of a display panel; information set for each line of the display panel; and information set for an individual pixel of the display panel.

For example, the Data Enable may be a timing signal in which information for updating a preset zone is reflected. Accordingly, the Data Enable may be a signal that is on or activated during a section corresponding to the preset zone.

In step 1020, the display control apparatus may also determine update bits for each pixel of the display panel at separate time intervals based on a logic low section or a logic high section of the timing signal. The logic low or logic high section of the timing signal may be, for example, the on or off section of the Data Enable shown in FIGS. 6 to 8.

In step 1030, the display control apparatus may transmit the determined update bits to the display panel. For example, a panel interface may transmit the update bits to the display panel on a line basis or a pixel basis.

In step 1040, the display panel may perform maintenance or update of the in-pixel memory on a line basis or pixel basis based on the update bits. In other words, in step 1040, the display panel may write video data input in the enable section of the timing signal into the in-pixel memory of pixels provided at display positions requiring updates.

The writing step may include controlling updates of the in-pixel memory on a line basis of the display panel based on the row information.

The writing step may also include generating update bits indicating whether to update display pixels corresponding to the row information and the column information, and updating the in-pixel memory of the display pixels or maintaining the data stored in the in-pixel memory based on the update bits.

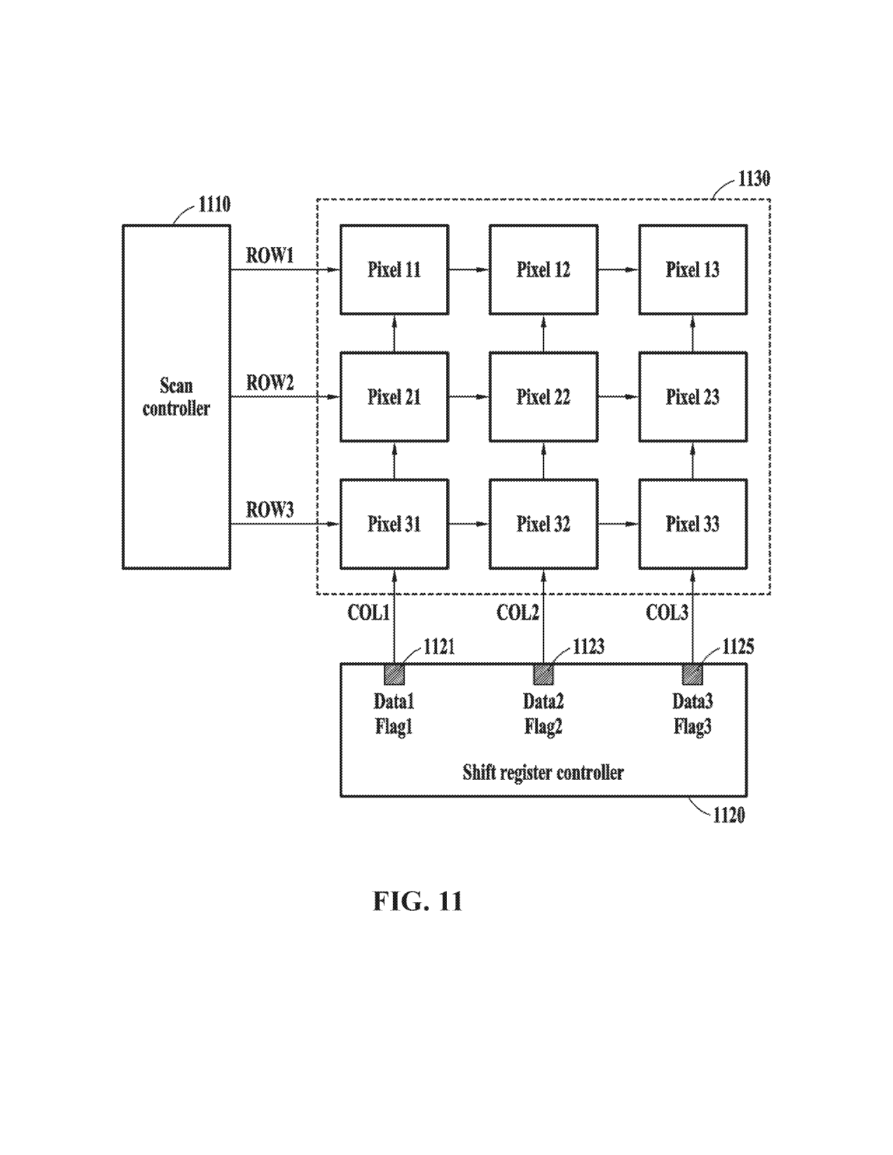

FIG. 11 is a diagram for explaining an example of a display control apparatus according to another embodiment of the present disclosure.

Referring to FIG. 11, the display control apparatus may include a scan controller 1110, a shift register controller 1120, and a pixel array 1130.

The scan controller 1110 and the shift register controller 1120 may be components included in the panel interface 125 of FIG. 1.

The pixel array 1130 may include nine pixels arranged in a 3×3 matrix. Specifically, pixels 11, 12, and 13 may be disposed in a first line (ROW1); pixels 21, 22, and 23 may be disposed in a second line (ROW2); and pixels 31, 32, and 33 may be disposed in a third line (ROW3). Each pixel may include an in-pixel memory for storing pixel data.

The scan controller 1110 may output sequential line activation signals for respective lines of the pixel array 1130. For example, the scan controller 1110 may sequentially activate each line through ROW1, ROW2, and ROW3 signals.

The shift register controller 1120 may transmit pixel data and flag bits for each column of the pixel array 1130.

The shift register controller 1120 may transmit Data1 and Flag1, Data2 and Flag2, and Data3 and Flag3 through a first column (COL1) 1121, a second column (COL2) 1123, and a third column (COL3) 1125, respectively.

The shift register controller 1120 may logically generate flag bits (Flag1, Flag2, Flag3) indicating whether to update pixel data of each pixel included in a line activated by the line activation signal. The flag bits may be generated based on a timing signal in which display pixel information to be updated is reflected.

Each pixel included in the activated line may selectively updates the pixel data stored in the in-pixel memory based on the line activation signal input from the scan controller 1110 and a logic value of the flag bit input from the shift register controller 1120.

For example, when ROW1 is activated, if Flag1 is "1," pixel 11 is updated with Data1; if Flag2 is "0," pixel 12 maintains existing data; and if Flag3 is "0," pixel 13 also maintains existing data. In this manner, each pixel is selectively updated according to the result of a logical AND operation between the line activation signal and the flag bit.

Accordingly, additional storage space for the flag bit in the in-pixel memory is unnecessary, thereby reducing the memory and driver area of each pixel. In particular, by not allocating a separate flag bit region in the in-pixel memory, the size of the pixel driver can be effectively reduced, which can improve the integration density of the display driving circuit.

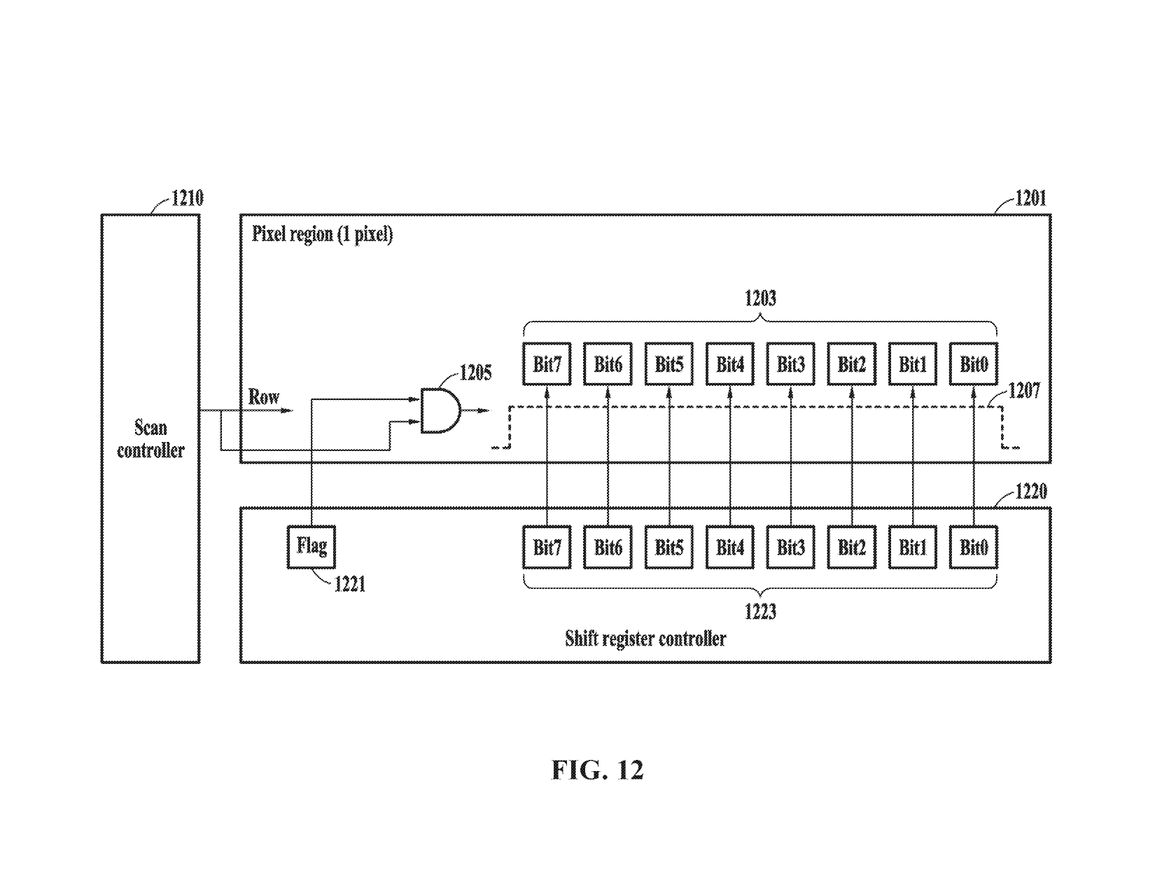

FIG. 12 is a diagram for explaining an internal configuration and operation of an individual pixel in FIG. 11.

Referring to FIG. 12, a pixel region 1201 represents a structure for controlling an update of an in-pixel memory by receiving signals from a scan controller 1210 and a shift register controller 1220.

The scan controller 1210 outputs sequential line activation signals (Row) on a line basis to the pixel region 1201. The line activation signal serves as a basic control signal that enables a memory update operation for all pixels belonging to the corresponding line.

The shift register controller 1220 transmits pixel data and a flag bit to the pixel region 1201. The shift register controller 1220 may receive pixel data from a logic controller. In addition, the shift register controller 1220 may receive a timing signal from the logic controller in which display pixel information to be updated is reflected, and may logically generate the flag bit based on the timing signal. Furthermore, the shift register controller 1220 may compare the pixel data received from the logic controller with data previously stored to determine whether to update the corresponding pixel. The display pixel information to be updated may include any one of: information for a preset zone of a display panel; information set for each line of the display panel; and information set for an individual pixel of the display panel.

For example, the pixel data may be display data represented as a multi-bit value from the most significant bit (MSB) Bit7 to the least significant bit (LSB) Bit0. The shift register controller 1220 may check whether to update the corresponding pixel, and may transmit 8-bit pixel data 1223 and a 1-bit flag bit 1221 to the corresponding pixel.

Each pixel 1201 may include pixel update control logic circuit 1205 and an in-pixel memory 1203. The pixel update control logic circuit 1205 performs a logical AND operation of the line activation signal (Row) input from the scan controller 1210 and the flag bit (Flag) input from the shift register controller 1220, and outputs a pixel update control signal 1207. The pixel update control signal 1207 may be referred to as a "in-pixel memory update enable signal." The flag bit indicates whether to update the pixel data of the corresponding pixel, and when the logic value is "1," an update is performed, and when the logic value is "0," the existing data is maintained.

The in-pixel memory 1203 stores only display pixel data and does not include a separate storage area for the flag bit. The in-pixel memory 1203 may selectively maintain or update the pixel data based on the pixel update control signal 1207 output from the pixel update control logic circuit 1205.

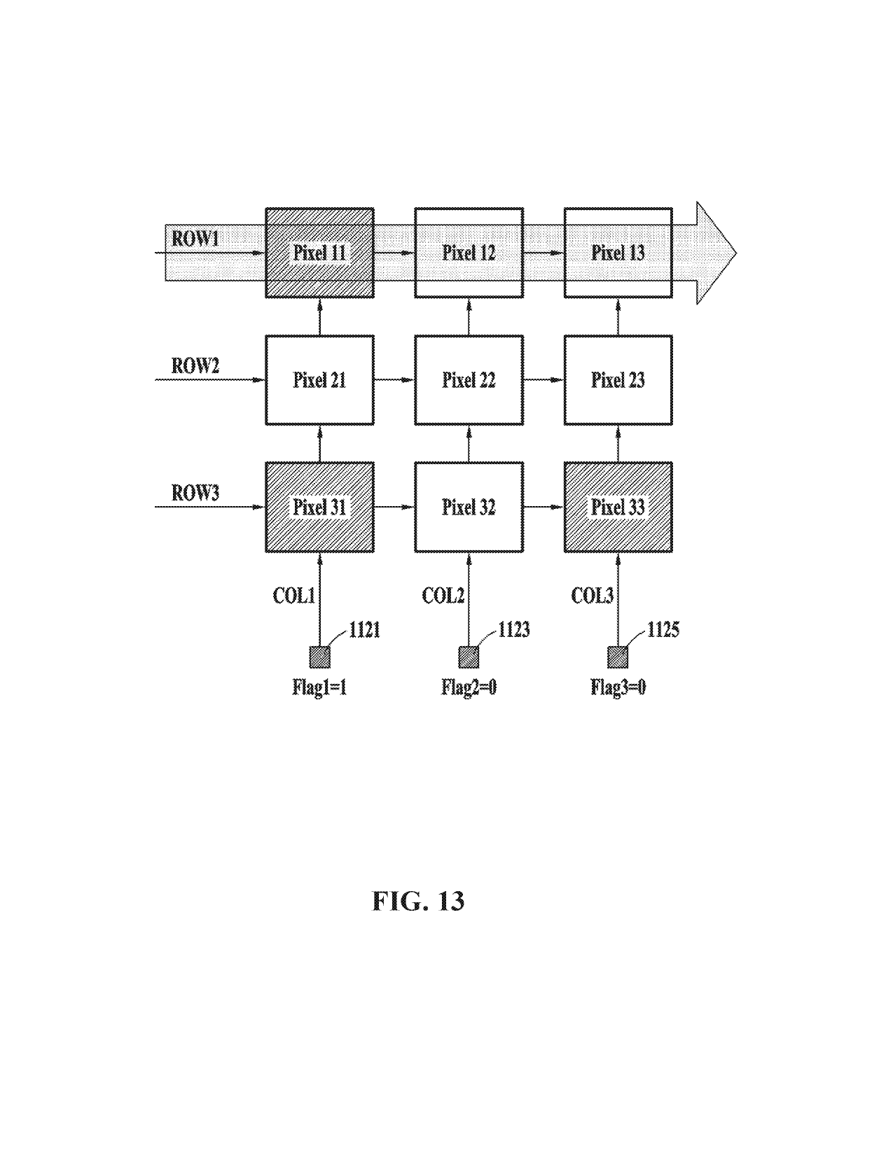

FIGS. 13 to 15 are diagrams for explaining examples of pixel-level partial updates in FIG. 11.

Here, the writing of pixel data may be executed for the entire pixel array, and pixel data updates may be performed only for some pixels in the pixel array whose data changes according to the flag bits.

For example, in the pixel array shown in FIG. 11, pixel 11, pixel 31, and pixel 33 may be partially updated.

Referring to FIG. 13, a ROW1 line activation signal is output from the scan controller 1110, indicating that the pixels in the first line (pixel 11, pixel 12, and pixel 13) are activated. In this case, the shift register controller 1120 transmits Flag1=1 through the first column (COL1) 1121, and transmits Flag2=0 and Flag3=0 through the second column (COL2) 1123 and the third column (COL3) 1125, respectively.

Pixel 11 updates its in-pixel memory with new data (Data1) according to the result of the logical AND operation between the line activation signal (ROW1=1) and the flag bit (Flag1=1). In contrast, since the flag bits for pixel 12 and pixel 13 (Flag2=0 and Flag3=0) are "0," the result of the logical AND operation is "0" even though the line activation signal is "1," and thus the previously stored pixel data is maintained. As such, selective pixel data updates can be performed within the same line according to the flag bits.

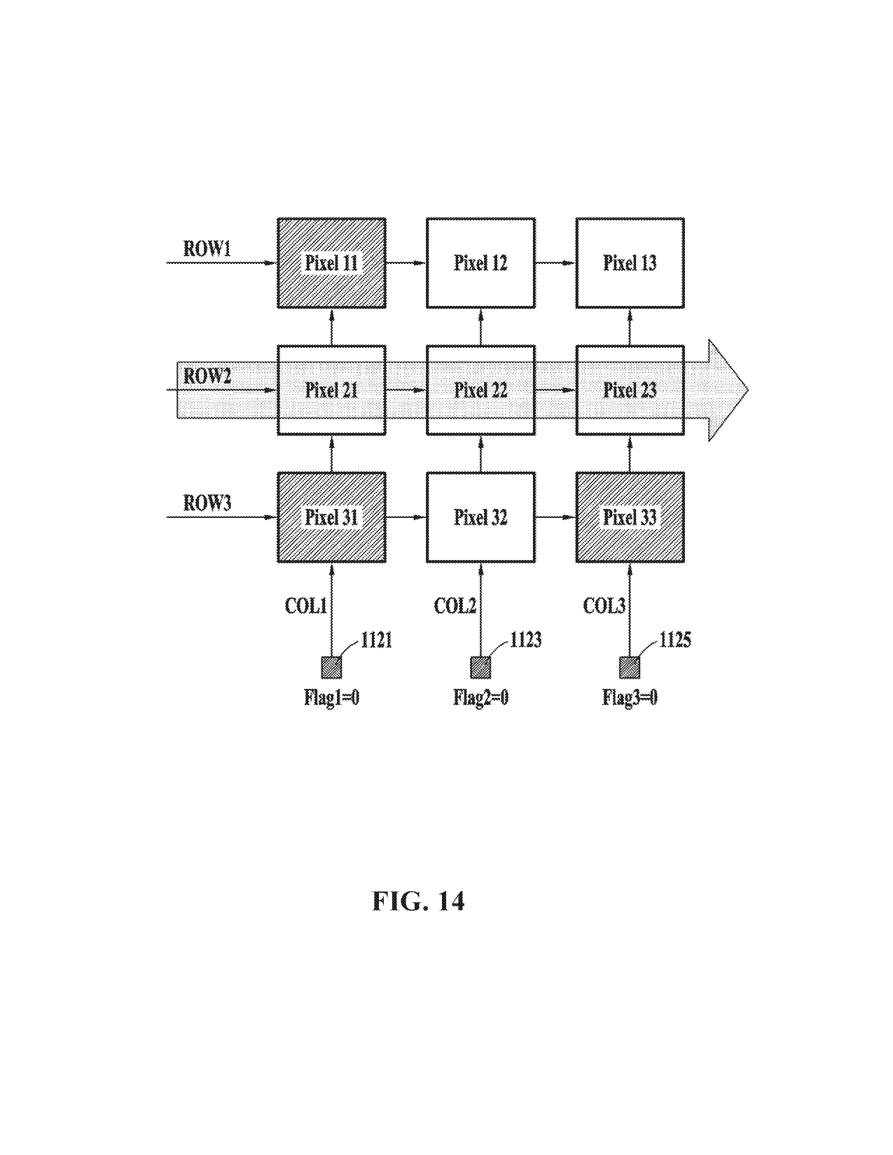

Referring to FIG. 14, a ROW2 line activation signal is output from the scan controller 1110, indicating that the pixels in the second line (pixel 21, pixel 22, and pixel 23) are activated. In this case, the shift register controller 1120 transmits Flag1=0, Flag2=0, and Flag3=0 through all columns.

Although the line activation signal (ROW2=1) for all pixels in the second line is "1," all flag bits are "0," so the result of the logical AND operation is "0" for all pixels. Therefore, pixel 21, pixel 22, and pixel 23 all maintain the previously stored pixel data, and no pixel data updates are performed. This represents a case where no pixels in the corresponding line require an update.

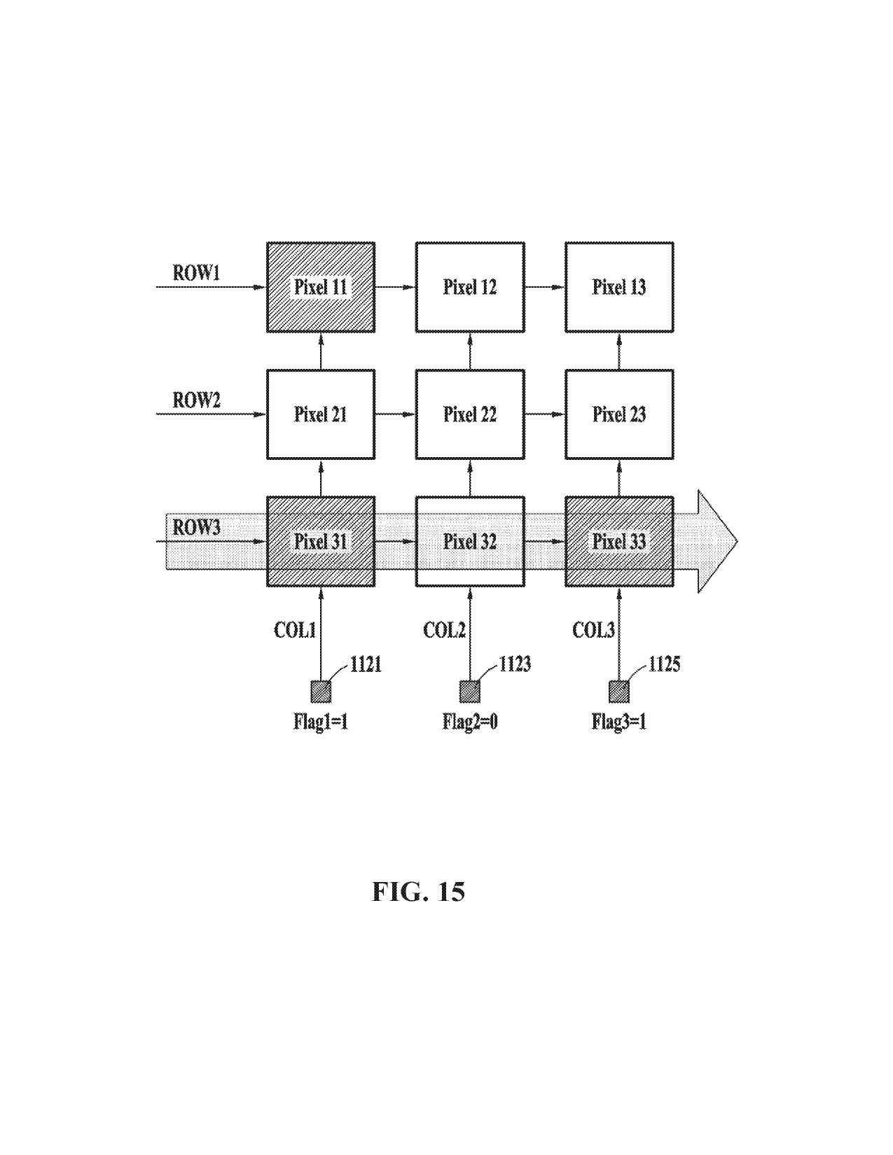

Referring to FIG. 15, a ROW3 line activation signal is output from the scan controller 1110, indicating that the pixels in the third line (pixel 31, pixel 32, and pixel 33) are activated. In this case, the shift register controller 1120 transmits Flag1=1 through the first column (COL1) 1121, Flag2=0 through the second column (COL2) 1123, and Flag3=1 through the third column (COL3) 1125.

Pixel 31 updates its in-pixel memory with new data (Data1) according to the result of the logical AND operation between the line activation signal (ROW3=1) and the flag bit (Flag1=1). Pixel 32 maintains the existing pixel data since the flag bit (Flag2=0) is "0." Pixel 33 updates its in-pixel memory with new data (Data3) according to the result of the logical AND operation between the line activation signal (ROW3=1) and the flag bit (Flag3=1). As such, even within the same line, partial updates can be selectively performed for non-contiguous pixels.

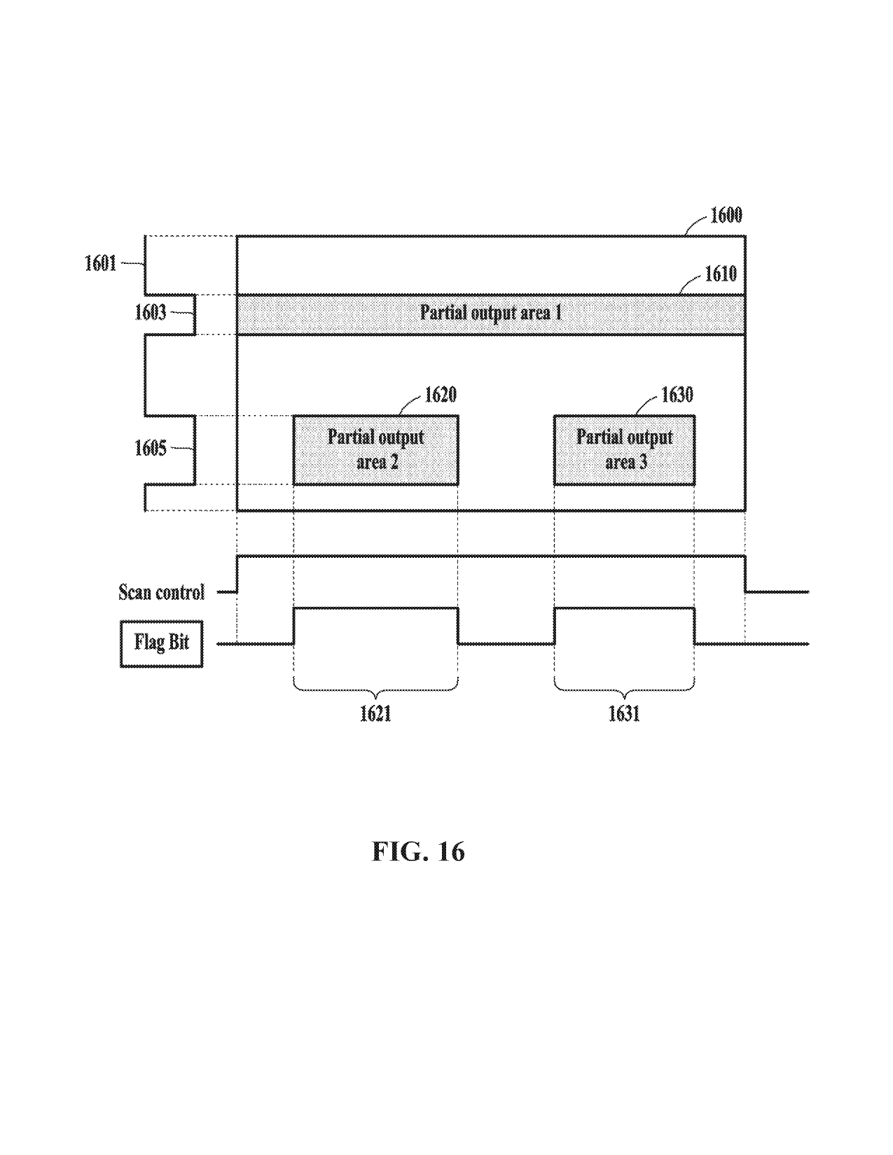

FIG. 16 is a diagram for explaining examples of line update control, pixel update control, and memory update control according to an embodiment of the present disclosure.

Referring to FIG. 16, a pixel array or display panel 1600 has a plurality of pixels arranged in a matrix form, and each pixel includes an in-pixel memory. In the display panel 1600, a partial output area 11610, a partial output area 21620, and a partial output area 3 1630 are set.

A line update control signal 1601 may be a control signal that enables a memory update operation for pixels in a specific line.

An in-pixel memory update enable signal 1603 indicates that the update of the in-pixel memory is activated for the pixels included in the partial output area 11610. In this case, the memory of the pixels in the corresponding area is updated with new pixel data.

Similarly, an in-pixel memory update enable signal 1605 indicates that the update of the in-pixel memory is activated for the pixels included in the partial output area 21620 and the partial output area 3 1630.

When the line activation signal of the scan controller is in an enabled state, the memory update of the pixels included in the partial output area 21620 may be executed in a section 1621 where the flag bit is enabled.

In addition, when the line activation signal of the scan controller is in an enabled state, the memory update of the pixels included in the partial output area 31630 may be executed in a section 1631 where the flag bit is enabled.

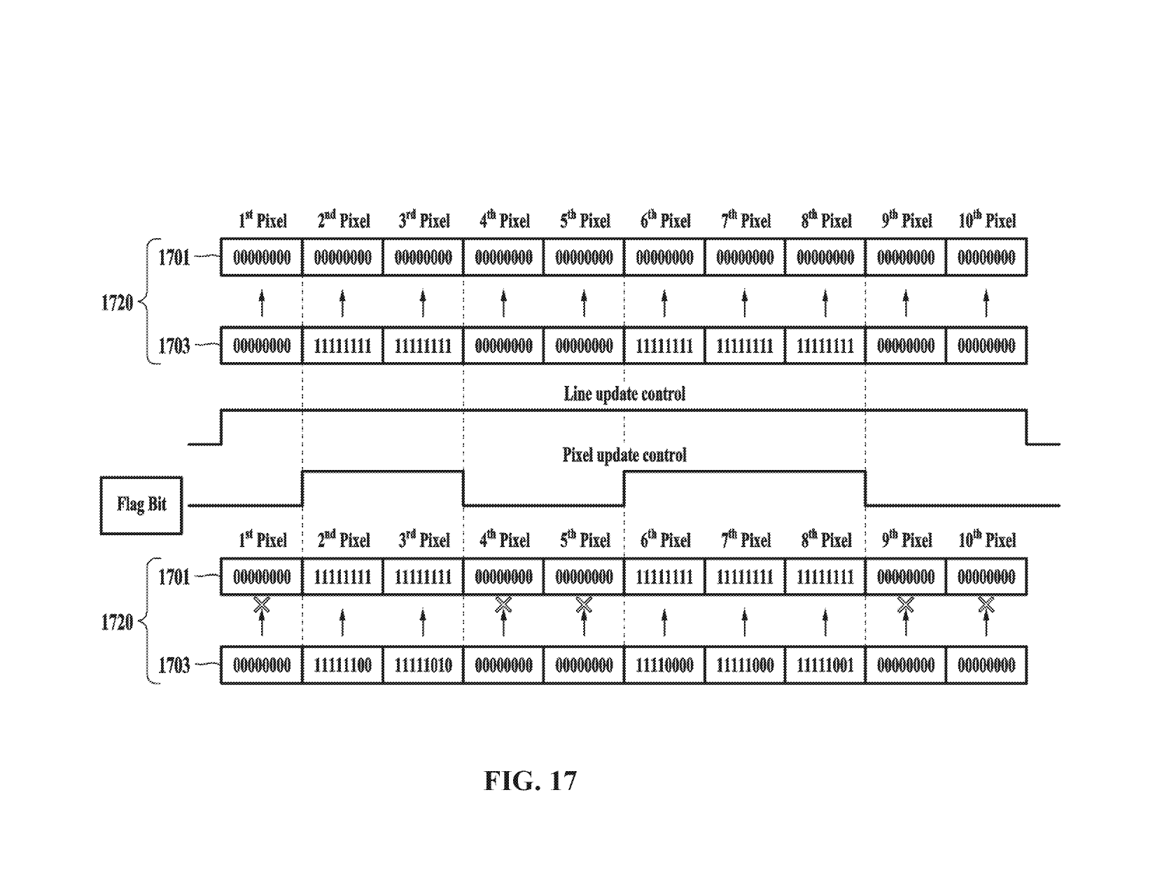

FIG. 17 is a diagram for explaining an example of the operation of an in-pixel memory and a shift register controller according to an embodiment of the present disclosure.

Referring to FIG. 17, a partial update operation process in one line composed of ten pixels is illustrated. The in-pixel memory 1701 may store 8-bit pixel data for each of the first through tenth pixels, and the shift register controller 1703 may provide pixel data and a flag bit corresponding to each pixel.

In a data write process 1710 for all pixels, the in-pixel memory 1701 of all pixels is set to an initial state of "00000000." At this time, the shift register controller 1703 transmits data "11111111" to the second, third, sixth, seventh, and eighth pixels, and data "00000000" to the remaining pixels.

In a partial update process 1720 for pixels requiring pixel data updates, selective updating is performed using the flag bit. A partial update may be executed only in the second, third, sixth, seventh, and eighth pixel regions according to the pixel update control signal.

In this case, only pixels whose flag bit is "1" are updated with new data, while pixels whose flag bit is "0" maintain the existing data. For example, the second pixel may be updated from "11111111" to "11111100," the third pixel from "11111111" to "11111010," the sixth pixel from "11111111" to "11111000," the seventh pixel from "11111111" to "11111000," and the eighth pixel from "11111111" to "11111001.

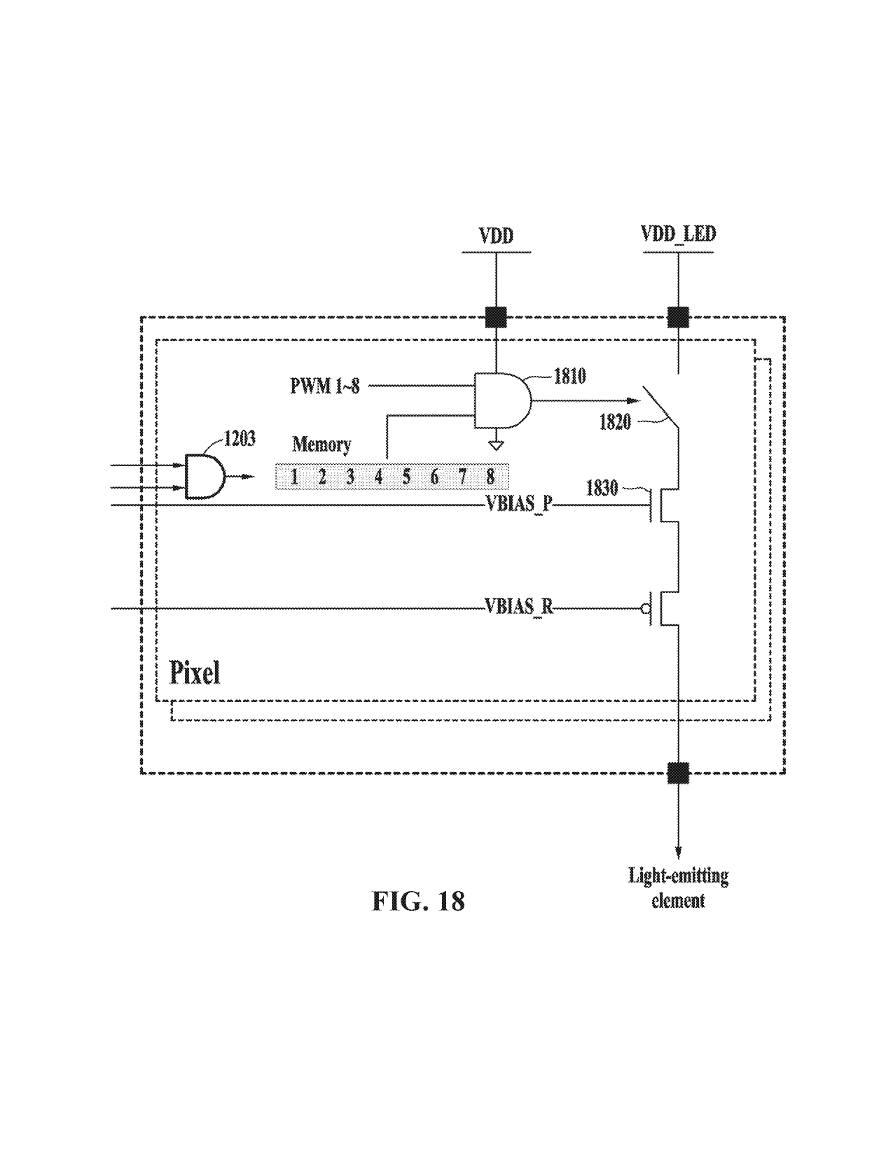

FIG. 18 is a diagram illustrating an example of a pixel driving circuit provided for each pixel according to an embodiment of the present disclosure.

The pixel driving circuit may include pixel update control logic circuit 1205, a memory, an operation unit 1810, a PWM switch 1820, and a driver 1830.

The operation unit 1810 may output a driving signal after an update of the in-pixel memory. The operation unit 1810 may combine gradation data output from the in-pixel memory with a PWM signal to output a driving signal. The driving signal may be used as a signal for switching the PWM switch 1820.

For example, when a specific bit of the in-pixel memory is "1" and the corresponding PWM signal is activated, the PWM switch 1820 outputs a driving signal corresponding to the bit. Conversely, when a specific bit of the in-pixel memory is "0" or the corresponding PWM signal is deactivated, no driving signal is output for the bit.

The driver 1830 receives the driving signal output from the PWM switch 1820 and supplies an appropriate current or voltage for driving a light-emitting element. The driver 1830 may control the driving conditions of the light-emitting element using bias voltages such as VBIAS_P and VBIAS_R.

The light-emitting element emits light according to the current supplied from the driver 1830, and the gradation of the corresponding pixel may be expressed through a light emission time determined by the duty ratio of the PWM signal.

VDD and VDD_LED respectively represent a supply voltage for circuit operation and a supply voltage for driving the light-emitting element.

The above-described apparatus may be implemented using hardware components, software components, and/or a combination of hardware and software components. For example, the apparatus and components described in the embodiments, such as the scan controller 1110, the shift register controller 1120, and the pixel update control logic circuit 1205 may be implemented using one or more general-purpose computers or special-purpose computers, such as a processor, a controller, an ALU (arithmetic logic unit), a digital signal processor, a microcomputer, an FPA (field programmable array), a PLU (programmable logic unit), a microprocessor, or any other apparatus capable of executing and responding to instructions. The processing apparatus may execute an operating system (OS) and one or more software applications running on the operating system. In response to the execution of software, the processing apparatus may access, store, manipulate, process, and generate data. For convenience of explanation, cases have been described in which a single processing apparatus is used; however, those skilled in the art will understand that the processing apparatus may include multiple processing elements and/or multiple types of processing elements. For example, the processing apparatus may include multiple processors, or one processor and one controller. Other processing configurations, such as a parallel processor, are also possible.

The software may include a computer program, code, instructions, or a combination of one or more thereof, which may configure the processing apparatus to operate as desired or instruct the processing apparatus to operate independently or collectively. The software and/or data may be embodied, permanently or temporarily, in any type of machine, component, physical apparatus, virtual equipment, computer storage medium or apparatus, or transmitted signal wave, for interpretation by the processing apparatus or for providing instructions or data to the processing apparatus. The software may also be distributed over a networked computer system, stored or executed in a distributed manner. The software and data may be stored in one or more computer-readable recording media.

A method according to an embodiment may be implemented in the form of program instructions that can be executed via various computer means, and may be recorded in a computer-readable medium. The computer-readable medium may include program instructions, data files, data structures, or a combination thereof. The program instructions recorded in the medium may be specifically designed and configured for the embodiments, or may be known and available to those skilled in the art of computer software. Examples of computer-readable recording media include magnetic media such as hard disks, floppy disks, and magnetic tape; optical media such as CD-ROMs and DVDs; magneto-optical media such as floptical disks; and hardware apparatus specially configured to store and execute program instructions, such as ROM, RAM, and flash memory. Examples of program instructions include machine code, such as that generated by a compiler, as well as high-level language code that can be executed by a computer using an interpreter or the like. The above-described hardware apparatus may be configured to operate as one or more software modules to perform the operations of the embodiments, and vice versa.

Although embodiments have been described above with reference to limited drawings, those skilled in the art will appreciate that various modifications and variations are possible from the above description. For example, the described techniques may be performed in an order different from the described method, and/or the components of the described system, structure, apparatus, or circuit may be combined or arranged in forms different from the described method, or replaced or substituted with other components or equivalents, without departing from the scope of the present disclosure.

Therefore, other implementations, other embodiments, and equivalents to the claims also fall within the scope of the claims set forth below.

What is claimed is:

1. A display control apparatus comprising:
a pixel array including pixels, each pixel having an in-pixel memory for storing pixel data;
a processor configured to:
output sequential line activation signals for respective lines of the pixel array; and
logically generate a flag bit indicating whether to update pixel data of each pixel included in a line activated by the line activation signal,
wherein each pixel included in the activated line selectively updates the pixel data stored in the in-pixel memory based on the line activation signal and a logic value of the flag bit.

2. The display control apparatus of claim 1, wherein the processor is configured to output a pixel update control signal by performing a logical AND operation of the line activation signal and the flag bit,
wherein the in-pixel memory included in each pixel maintains or updates the pixel data based on the pixel update control signal.

3. The display control apparatus of claim 1, wherein the processor is configured to receive a timing signal reflecting information of display pixels to be updated, and logically generate the flag bit based on the timing signal.

4. The display control apparatus of claim 3, wherein the display pixel information to be updated includes any one of: information for a preset zone of a display panel; information set for each line of the display panel; and information set for an individual pixel of the display panel.

5. The display control apparatus of claim 1, wherein the processor is configured to transmit the pixel data and the flag bit for each column of the pixel array.

6. The display control apparatus of claim 1, wherein the in-pixel memory stores only display pixel data for display purposes and does not include a separate storage area for the flag bit.

7. The display control apparatus of claim 1, wherein when the flag bit has a first logic value, the in-pixel memory of a corresponding pixel is updated with new pixel data, and when the flag bit has a second logic value, the in-pixel memory of the corresponding pixel maintains previously stored pixel data.

8. A method for driving a display having a pixel array in which pixels including in-pixel memories are arranged, the method comprising:
outputting, sequential line activation signals for respective lines of the pixel array;
logically generating a flag bit indicating whether to update pixel data of each pixel included in a line activated by the line activation signal; and
selectively updating, by each pixel included in the activated line, the pixel data stored in the in-pixel memory based on the line activation signal and a logic value of the flag bit.

9. The method of claim 8, wherein the selectively updating the pixel data comprises:
generating, by each pixel, a pixel update control signal by performing a logical AND operation of the line activation signal and the flag bit; and
maintaining or updating, based on the pixel update control signal, the pixel data in the in-pixel memory.

10. The method of claim 8, wherein the logically generating of the flag bit comprises:
receiving a timing signal reflecting display pixel information to be updated; and
logically generating the flag bit based on the timing signal.

11. The method of claim 8, wherein the selectively updating the pixel data comprises:
updating, when the flag bit has a first logic value, the in-pixel memory of a corresponding pixel with new pixel data, and maintaining, when the flag bit has a second logic value, previously stored pixel data in the in-pixel memory of the corresponding pixel.

12. A display control apparatus for low-power operation, comprising:
a receiving interface configured to receive a timing signal from a host device, the timing signal reflecting display position information which is requiring updates in entire frame data;
a processor configured to check a preset porch section and an enable section of the timing signal, and to determine a display position corresponding to the enable section of the timing signal; and
a panel interface configured to transmit video data input in the enable section of the timing signal to a display panel so as to write the video data to pixels provided at the display position.

13. The display control apparatus of claim 12, wherein the processor is configured to:
determine row information of the display position based on a horizontal synchronization signal included in the timing signal, and determine column information based on a time counted from an end of the porch section to the enable section of the timing signal.

14. The display control apparatus of claim 13, wherein the processor is configured to:
generate update bits indicating whether to update display pixels corresponding to the row information and the column information.

15. The display control apparatus of claim 14, wherein:
pixels of the display panel receive the update bits and determine whether to reset or maintain an in-pixel memory of the pixels based on the update bits.
